(19) United States
(12) Patent Application Publication
(10) Pub. No.: US 2009/0252436 A1
(43) Pub. Date: Oct. 8, 2009

(54) Method for visualization of multidimensional data

(75) Inventors: Dmitri Eidenzon, Waterloo (CA); Vitali Volovodenko, Tomsk (RU)

Correspondence Address: Novospark Corporation, 418 Dansbury Dr, Waterloo, ON, N2K 3X8, CA

(73) Assignee: NovoSpark Corporation, Waterloo (CA)

(21) Appl. No.: 12/395,780

(22) Filed: Mar. 2, 2009

Related U.S. Application Data
(60) Provisional application No. 61/041,901, filed on Apr. 2, 2008.

(51) Int. Cl. G06K 9/36

(52) U.S. Cl. 382/285; 382/280; 382/162

(57) ABSTRACT

The method provides a visualization technique for rendering multidimensional data points as 2D curves on a 3D plot with the third dimension representing their order in the multidimensional data set. The technique uses colour palettes to render individual data curves, which enables visual analysis of the entire dataset based on the colour characteristics of the resulting image. The method also suggests a technique for: a) visualizing a distance between multidimensional data points; c) showing a linear segment between two multidimensional data points; d) displaying a colour map of an individual multidimensional point or data set; e) displaying a multidimensional data interval.

### CROSS-RELATED APPLICATIONS

This application claims benefit of provisional patent application 61/041,901, filed on Apr. 2, 2008.

### OTHER REFERENCES

1. Chernoff, Herman, “The Use of Faces to Represent Points in k-Dimensional Space Graphically,” Journal of the American Statistical Association, v. 68, 1973, pp 361-368.

2. Beshers, C. and Feiner, S. “AutoVisual: Rule-based design of interactive multivariate visualizations,” IEEE Computer Graphics and Applications, 13(4), July 1993, 41-49.

3. Embrechts, P. and Herzberg A. “Variations of Andrews' Plots,” International Statistical Review/Revue Internationale de Statistique, Vol. 59, No. 2. (August 1991), pp. 175-194.

### TECHNICAL FIELD AND INDUSTRIAL APPLICABILITY OF THE INVENTION

This invention relates to visualization and graphical analysis of sets of data points from multidimensional domain. It can be applied to any experiment or research process that involves gathering and analysis of observations with multiple parameters.

### DESCRIPTION OF THE PRIOR ART

Any research involving analysis of data observations with one or more dimensions becomes more efficient if it utilizes visualization techniques that help to quickly understand data structure. Superior ability of the human eye to catch visual patterns allows data visualization to be a powerful tool in finding hidden trends and relationships between individual observations in a multidimensional data set.

For data sets with up to three dimensions standard visualization methods of presenting observations as data points on a 2D or 3D scatter plot diagram can be used. In cases when there is more than three dimensions some kind of transformation is required before the image can be presented for analysis.

A number of prior art techniques for visualization of high dimensional data exist today. For example, many visualization methods revolve around a method, where values of individual data variables are embodied in specific parts of colored glyphs, as described in H. Chernoff, “The Use of Faces to Represent Points in k-Dimensional Space Graphically”, Journal of the American Statistical Association, v. 68, 1973, pp 361-368, or as rays of star objects in a star diagram. In both cases the methods allow for visual comparison of individual observations but are limited in the number of dimensions they can represent without cluttering the image, and become very hard to derive behavioral patterns from for data sets with high number of observations.

Other methods suggest projecting multidimensional data sets on a two-dimensional or pseudo three-dimensional plane, as described in C. Beshers, S. Feiner, “AutoVisual: Rule-based design of interactive multivariate visualizations,” IEEE Computer Graphics and Applications, 13(4), July 1993, 41-49. This approach requires tremendous analysis effort in finding the best plane or combination of planes that would present the most useful information about the structure or behavior of the original data set.

The method described in Embrechts, P. and Herzberg A. “Variations of Andrews' Plots,” International Statistical Review/Revue Internationale de Statistique, Vol. 59, No. 2. (August 1991), pp. 175-194 transforms each N-dimensional data point into a Fourier series function and renders it as a plot in a 2D space. This allows to compare individual data points by visually comparing the shapes of their 2D plots, but the resulting image would not visualize the behaviour of an ordered data set, and will become very cluttered as more 2D plots are added to show more data points from the same data set.

Thus, there remains a need for a method to produce a diagram that can visualize structural and behavioral patterns in a multidimensional data set without making the image too difficult to comprehend, especially for data sets with high number of observations.

### SUMMARY OF THE INVENTION

One object of the invention is to transform each multidimensional data point into a 2D plot and render it in 3D space. This gives the ability to visualize the distance between individual data points and show the structure of each data cluster formed by adjacent 2D plots. Another object is to show linear transitions between individual data points in an ordered data set, visualizing behavior of a dynamic multidimensional process represented by this data set. A further object is to facilitate comparison of individual data points or trends of the entire data process by visualizing distribution of colors from a multicolor palette according to the shapes of their 2D plots. Yet another object of the invention is to visualize multidimensional data interval for easy identification of data anomalies.

Other features and advantages of the present invention will become apparent from the following description taken in conjunction with the accompanying drawings.

### BRIEF DESCRIPTION OF THE DRAWINGS

The objects and advantages of the present invention, as well as additional objects and advantages thereof, will be more fully understood hereinafter as a result of a detailed description of a preferred embodiment when taken in conjunction with the following drawings in which:

FIG. 1 shows a 2D plot of a multidimensional data point.

FIG. 2A represents a 3D image of a multidimensional data set and Z-axis.

FIG. 2B shows all axes in the 3D Euclid space containing the image in FIG. 2A.

FIG. 3 shows the F(Z) projection of the image in FIG. 2B.

FIG. 4 shows spectrum bars of individual data points.

FIG. 5 shows a multidimensional data segment.

FIG. 6 shows the Z(t) view of a continuous data process with applied color mapping.

FIG. 7 illustrates the F(t) projection of the multidimensional data interval.

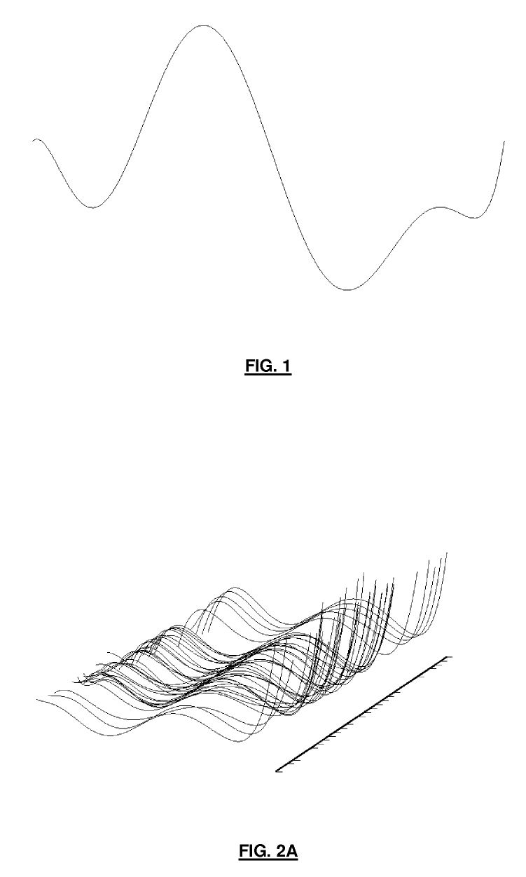

### DETAILED DESCRIPTION OF THE PREFERRED EMBODIMENTS

The present invention transforms multidimensional data points into a set of 2D plots arranged along a third dimension according to their order in the multidimensional data set. It does so by converting each record into a 2D Fourier series function and rendering it on an imaginary plane oriented perpendicular to the axis of this dimension, placed at a distance proportional to the calculated order value of the corresponding data point.

The method of visualizing a multidimensional data set is comprised of the following steps:

1) A data point A=(a₁, a₂, . . . , a_{N}) in an N-dimensional space is transformed into a Fourier series function and rendered as a 2D plot using the formula

$$F ( t ) = {\sum }_{i = 1}^{N} {{a}_{i}}^{*} {P}_{i} ( t ) ( see Fig . 1 for an example ) ,$$

wherein:

t varies in the interval [0, 1],

aᵢ is the value of the i-th dimension,

Pᵢ(t) is any orthogonal polynomial of degree i, e.g. Legendre polynomial.

2) Each N-dimensional data point Aᵢ in a data set D={A₁, A₂, . . . , A_{M}) is assigned a value Zᵢ that identifies an order of the data point in data set D, like a moment of time the observation represented by point Aᵢ was taken in a time-dependant dynamic process, or Euclid distance of a data point in an N-dimensional space.

3) Each imaginary plane containing a 2D plot from step 1 is re-oriented in 3D space and placed perpendicular to an axis on the 3D image, at a distance from the origin proportional to the Z-value of its data point assigned in step 2.

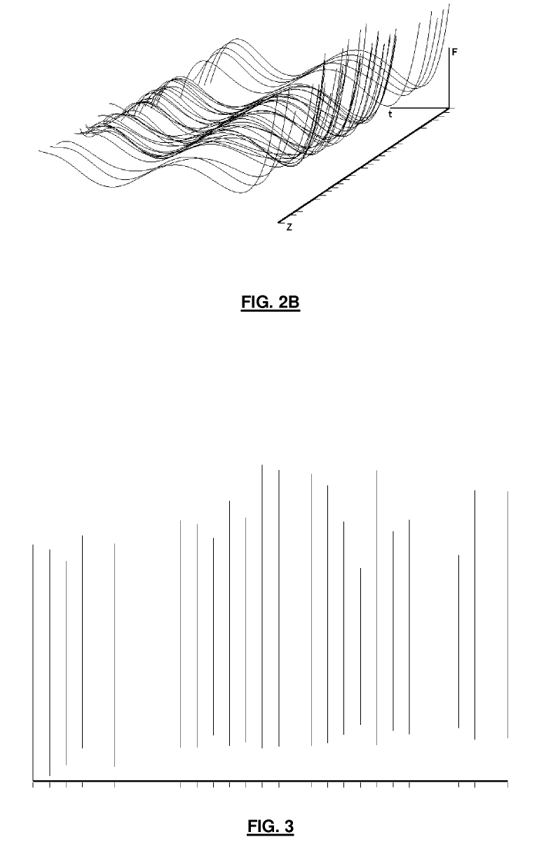

FIG. 2A shows the 3D image of a sample data set, where each 2D plot is marked as a little tick on the Z-axis. As shown in FIG. 2B, if the axes used to render 2D plots on the imaginary planes in step 1 are also visualized on this image, then the entire diagram will be viewed as a graph in a three-dimensional Euclid space with the following mutually orthogonal axes:

t-axis for a parameter varying in the interval [0, 1].

F-axis for values of Fourier series functions built for each 2D plot.

Z-axis for Z-values assigned to each data point in step 2.

As illustrated in FIG. 3, in the F(Z) projection, or “side” view, of the Euclid space defined above all 2D plots are seen as vertical lines located as close to each other as the Z-values assigned to their data points in step 2. The resulting image can be used to see clusters of related data points for the specified Z-order.

All information about a multidimensional data point is encoded in the shape of its 2D plot, and hence the ability to compare it with other plots is important. The invention allows seeing the differences between multiple data points by mapping a color lookup table to altitudes of their 2D plots calculated as values of the Fourier series function F(t) in step 1.

A k-color lookup table, or color palette, consists of a set of pairs P={(E₁, C₁), (E₂, C₂), . . . , (Eₖ, Cₖ)}, wherein:

each pair (Eᵢ, Cᵢ) is an element (Elevation, Color) with the i-th lowest elevation value,

elevations E vary in the interval [0, 1], with E₁ equal to 0 and Eₖ equal to 1,

C is a color component representing an ARGB (alpha, red, green, blue) color.

The color mapping for a data set with M data points is applied using the following algorithm:

1) The minimum out of all values of the Fourier series functions

$${min}_{1 \leq m \leq M} ( {F}_{m} ( t ) )$$

is matched with the elevation E₁ and rendered with the color C₁.

2) The maximum out of all values of the Fourier series functions

$${max}_{1 \leq m \leq M} ( {F}_{m} ( t ) )$$

is matched with the elevation Eₖ and rendered with the color Cₖ.

3) All other values of the Fourier series functions Fₘ(t)* are scaled proportionally to the interval [0, 1] and rendered using color C* that is derived from the following formula:
If Eᵢ=Fₘ(t)* the color C (or ARGB*) of the elevation Fₘ(t)* is set to Cᵢ.
If Eᵢ≦Fₘ(t)*<Eᵢ₊₁ the color C* (or ARGB*) of the elevation Fₘ(t)* is calculated as:

C*=Cᵢ+(Cᵢ₊₁−Cᵢ)(Fₘ(t)*−Eᵢ)/(Eᵢ₊₁−Eᵢ),
or more specifically

A*=Aᵢ+(Aᵢ₊₁−Aᵢ)(Fₘ(t)*−Eᵢ)/(Eᵢ₊₁−Eᵢ)

R*=Rᵢ+(Rᵢ₊₁−Rᵢ)(Fₘ(t)*−Eᵢ)/(Eᵢ₊₁−Eᵢ)

G*=Gᵢ+(Gᵢ₊₁−Gᵢ)(Fₘ(t)*−Eᵢ)/(Eᵢ₊₁−Eᵢ)

B*=Bᵢ+(Bᵢ₊₁−Bᵢ)(Fₘ(t)*−Eᵢ)/(Eᵢ₊₁−Eᵢ).

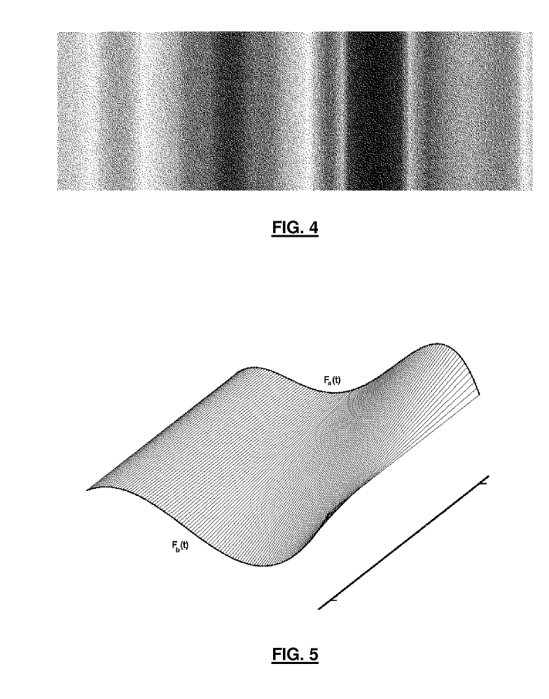

If every point on a 2D plot is stretched along the Z-axis and the resulting image is viewed in the Z(t) projection, or “top” view, the data point will be seen as a spectrum bar with palette colors representing the curvature of its 2D plot. As illustrated in FIG. 4, by performing the same graphical operation for several different data points and viewing them together on the same image it is easy to see how similar or different they are based on the color characteristics of their spectrum bars.

If A=(a₁, a₂, . . . , a_{N}) and B=(b₁, b₂, . . . , b_{N}) are two data points in an N-dimensional space, then the linear segment A̅B̅ can be defined as a Fourier series function Fₓ(t, λ)=Fₐ(t)+λ(F_{b}(t)−Fₐ(t)), wherein:

Fₐ(t) is a Fourier series function representing data point A,

F_{b}(t) is a Fourier series function representing data point B,

λ varies in the interval [0,1].

In the three-dimensional Euclid space described in this invention the multidimensional segment defined by function Fₓ(t, λ) can be rendered as a continuous surface connecting 2D plots Fₐ(t) and F_{b}(t) as illustrated in FIG. 5.

The color mapping can be applied to the surface using the above algorithm based on the elevation values of function Fₓ(t, λ). As shown in FIG. 6 by looking at the resulting image from the “top”, or in the Z(t) projection view, the entire data set will appear as a color bar, on which deviations from the normal data pattern are presented as color fluctuations.

In the cases where each parameter in an N-dimensional space is confined by an interval of minimum and maximum limits within which its values are allowed to vary, it is often beneficial to see the 2D plots of a multidimensional data set contained within an area representing a multidimensional data interval for this data set. The current invention allows to visualize such an area using the following steps:

1) For each parameter aᵢ in an N-dimensional space and the interval of values [aᵢ^{min}, aᵢ^{max}] defined for this parameter two new 2D plots Fₚ^{min}(t) and Fₚ^{max}(t) are defined for a multidimensional data set to represent the following two data points:

Pₘᵢₙ=(a₁^{min}, a₂^{min}, . . . , a_{N}^{min})

Pₘₐₓ=(a₁^{max}, a₂^{max}, . . . , a_{N}^{max})

2) In addition to plots Fₚ^{min}(t) and Fₚ^{max}(t) the data set is also defined N new 2D plots Fₚ_{ᵢ}(t) for each 1≦i≦N to represent data points Pᵢ=(a₁^{min}, a₂^{min}, . . . , aᵢ^{max}, . . . , a_{N}^{min}).

3) The minimum and maximum boundaries of the data interval area are first built in the F(t) projection, or “perspective” view, by connecting graphically the following points for each t in the interval [0, 1]:

$${F}^{min} ( t ) = {min}_{1 \leq i \leq N} ( {F}_{p}^{min} ( t ) , {F}_{{p}_{i}} ( t ) )$$

$${F}^{max} ( t ) = {max}_{1 \leq i \leq N} ( {F}_{p}^{max} ( t ) , {F}_{{p}_{i}} ( t ) )$$

4) To visualize the data interval area on the 3D image the minimum and maximum boundary curves are built using steps 1, 2 and 3 within the planes corresponding to minimum and maximum Z-values and graphically connected with a linear surface using the Fₓ(t, λ) function described above.

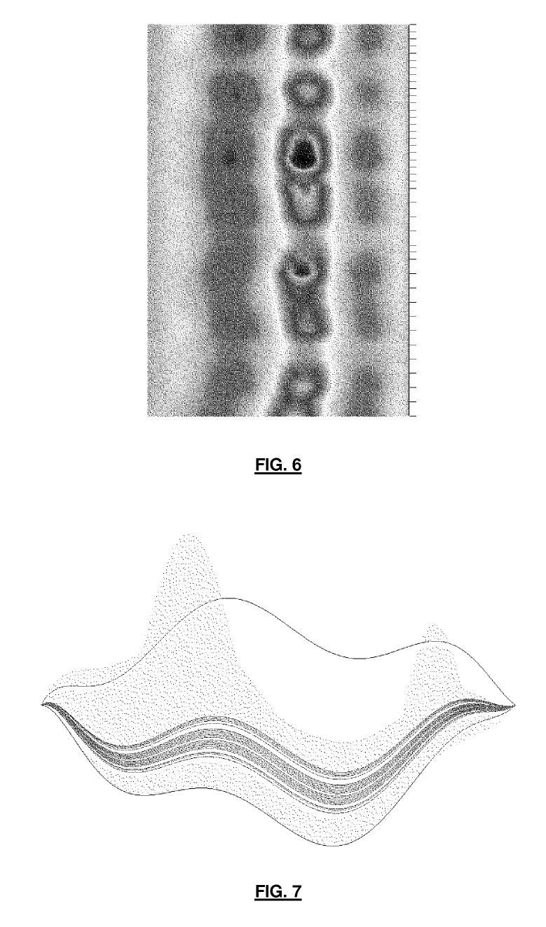

As illustrated in FIG. 7, the area obtained in step 3 will fully embrace 2D plots of all points with values within the specified data interval, whereas 2D plots of data points that lie outside of this interval in at least one dimension will extend past the area's boundaries in some parts of the image.

The invention has been described with reference to the preferred embodiment. Obviously, modifications and alterations will occur to others upon reading and understanding of this specification. It is intended to include all such modifications and alterations insofar as they come within the scope of the appended claims or the equivalents thereof.

What is claimed is:

1. A method for displaying a multidimensional data set on a 3D plot, comprising the steps of:
a) transforming each multidimensional data point into a 2D plot using a Fourier series function;
b) calculating an order value of each data point; and
c) rendering each 2D plot on an imaginary plane oriented perpendicular to an axis in 3D space, at a distance proportional to the order value of its data point;

2. The method of claim 1 wherein each 2D plot is rendered using a colour palette by mapping its colours to values of said plot function.

3. The method of claim 2 wherein said 2D plots are presented as spectrum bars.

4. The method of claim 1 wherein a shape representing a data interval for said multidimensional data set is displayed on said 3D plot.

5. The method of claim 1 wherein every two neighbouring 2D plots are graphically connected by a linear plane.

6. The method of claim 5 wherein said linear plane is rendered using a colour palette by mapping its colours to values between the two 2D plots the plane connects.
